(19) United States
(12) Patent Application Publication
(10) Pub. No.: US 2002/0024217 A1
(43) Pub. Date: Feb. 28, 2002

(54) THERMALLY RESPONSIVE COUPLING FOR FLUID-CARRYING LINES

(76) Inventor: THOMAS A MUMMERT, COLDWATER, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/284,572

(22) PCT Filed: Oct. 15, 1997
(86) PCT No.: PCT/US97/18437

(51) Int. Cl. F16L 55/00

(52) U.S. Cl. 285/187

(57) ABSTRACT

A fluid coupling (60) for connecting fluid conduits includes a thermally sensitive member (30) and a coupling nut (40) which fit together for conjoint operation. The thermally sensitive member (30) has a resiliently expanded end (36) which engages a cooperating structure (14) on a fluid-carrying member (10) to retain it in place while permitting relative rotation. The thermally sensitive member (30) has a flange portion (34) that, when assembled, is in axial shear between the coupling nut (40) and the fluid-carrying member (10). When exposed to excessive temperature, the flange portion (34) softens, allowing the fluid-carrying member (10) to move and an in-line valve to close, thus shutting off the flow of gas. In another embodiment, the thermally sensitive member (84) is a bushing that is received within the plug body (80) of a quick-disconnect type coupling. This thermally sensitive bushing is held in axial shear between a different type of fluid-carrying member (82) and an internal shoulder (100) of the plug body (80). When exposed to elevated temperature, the bushing softens to allow the fluid-carrying member (82) to move inside the plug body (80), thus permitting a valve member within an adjoining coupling to shut off fluid flow.

### BACKGROUND OF THE INVENTION

1. Field of the Invention

This invention relates generally to coupling devices for connecting two fluid-carrying conduits in end-to-end relation, as between a fluid source and fluid-utilizing device. More particularly, the invention relates to thermally sensitive fluid connection systems, especially for coupling gas lines, which incorporate a heat-sensitive element that allows the coupled sections to disconnect automatically when the system is exposed to temperatures above a predetermined minimum temperature.

2. Discussion of Related Art

Thermally sensitive coupling devices are often used to releasably join fluid-carrying tubes or the like, and various types of such devices have previously been proposed. In previous inventions, the components have been coupled with either a “quick-disconnect” connection, as in U.S. Pat. No. 4,290,440, or with a rotatable sleeve member mounted on one coupling section and adapted to engage the other coupling section, as in U.S. Pat. No. 4,911,194. Because these coupling devices often are used on lines which transport flammable material, e.g., natural or L.P. gas, it is desirable that they incorporate a safety feature to automatically shut off the fluid connection in the presence of excessive heat. Both of the above patents incorporate such a feature.

The coupling in U.S. Pat. No. 4,911,194 contains a threaded connecting sleeve, which has a heat-sensitive portion at one end and normally functions to connect the components of the system. Although incorporating the heat-sensitive feature in the threaded connecting member portion of the apparatus may have some desirable characteristics, a limitation of such a design is that the plastic used for the rotatable sleeve can have a sensitivity to certain commonly used cleaning chemicals and/or other agents which may be used to detect gas leakage. In addition, this type of device is rendered totally unusable when it thermally releases, since the heat-sensitive portion is integrated with the connecting sleeve itself. Further, by integrating the thermally responsive feature within the connecting sleeve, the coupling of the '194 patent is limited in that its thermally responsive feature cannot be optimally tailored to activate at a desired set of conditions without incurring substantial manufacturing expense. Accordingly, a need exists for a coupling which implements the thermally responsive feature in such a manner as to successfully overcome the aforementioned chemical sensitivity without compromising other important attributes. In particular, the improved design should not sacrifice the sensitivity of the thermally responsive feature of the coupling. If the coupling is exposed to a predetermined excessive temperature, the safety feature must reliably release the fluid connection.

One known thermally responsive coupling (U.S. Pat. No. 4,280,523) comprises a plug body which is held in a socket chamber by an annular collar. In turn, the collar is held on the plug body by a separate annular ring of fusible material which, when exposed to a predetermined excessive temperature, releases the plug body to shut off fluid communication in the system. Note that this is a two-piece system in which the collar is separate from the ring of fusible material. Although such two-piece systems are desirable because they are versatile, the construction of some of these systems is such that the independent fusible element often is not strong enough to counter the spring force exerted thereon even at normal temperatures, and thus may not prevent axial movement of the plug body over time, an undesirable characteristic that is known in the industry as “creep.” For instance, the fusible element of some such couplings is made of a material, such as solder, which melts and flows along the plug body upon thermal activation. Notably, such a ring of relatively soft material may render the coupling susceptible to creep, and thus fluid flow may be shut off without being subject to a fault condition. Further, such a coupling is often not adapted for ready assembly In particular, to accommodate a ring of solder, the plug body must often be modified by machining an annular groove in its cylindrical side surface, and, thereafter, accurately filling the groove with solder, which obviously comprises a laborious and time-consuming process. Therefore, the field of heat-sensitive couplings is in need of an improved design which incorporates an independent component that is sensitive to heat, adapted to retain a conventional fluid-carrying section without modification of the coupling components, and may be readily assembled.

### SUMMARY OF THE PRESENT INVENTION

Among the several objects of this invention that may be noted, the provision of a thermally sensitive coupling system comprising a thermally sensitive member and a coupling nut which are separate and independent members but which fit together for conjoint operation, whereby the nut is not adversely affected by thermal release of the heat-sensitive member and the combination may readily retain a fluid-carrying plug body or other such element.

In a preferred implementation, an elongated plug-like body (e.g., an L.P. gas POL fitting) provides the fluid-carrying section to be coupled between the gas supply and the appliance. When the coupling is fully assembled, the adjoining coupling part has an in-line valve that is in axial alignment with the plug (POL) body to ensure proper fluid flow through the coupling. Normally the in-line valve is held open due to a spring force between the plug (POL) body and the adjoining coupling part. In this preferred implementation, the thermally sensitive member is in the form of a bushing that is configured to retain the plug (POL) body within a bore inside the nut to act as both a bearing and a retainer between the nut and the plug body. The components inter-fit conjointly for convenient assembly while substantially eliminating or minimizing axial movement of the plug body at normal temperatures due to the presence of surfaces of the components which abut flush against each other, thus maintaining a highly secure connection. The thermally sensitive bushing element preferably has a flange portion which, when assembled, is loaded in axial shear between the nut and the plug body. When the coupling is exposed to an elevated temperature within a predetermined range, this flange will yield, allowing the applied spring force and the existing fluid pressure to axially move the plug body. Once the plug body so moves, the in-line valve closes to shut off the flow of gas between the fluid-carrying conduits. The flange of the bushing may contain a desired array of recesses or apertures positioned annularly around the bushing to selectively alter the thermal activation characteristics of the coupling.

In addition, in the preferred embodiment, the nut is manufactured from a glass fiber-reinforced Nylon 6 compound. This material affords high strength and resistance to chemical attack, and therefore, avoids the problem associated with some of the prior art devices described above. At the bushing end, the nut tapers and protrudes outwardly toward the horizontal axis of the coupling in a series of steps in order to maintain a relatively uniform wall thickness and to maximize bushing exposure to external heat. Therefore, even though the thermally sensitive element is contained within the coupling, the system remains suitably sensitive to the ambient heat associated with a fault condition. Importantly, the nut itself is intended not to distort or yield during the thermal activation of the system and, in any event, it is not necessary for the nut to distort or yield for thermal shutoff to occur.

In another embodiment of the thermally sensitive coupling, the above discussed thermal response feature, including a thermally sensitive bushing element, is utilized in a “Type II”(i.e., “quick disconnect”) connection having a different type of plug body (e.g., of the “quick-disconnect” variety) and an adjoining coupling part, such as a cylinder valve. In this embodiment, the thermal bushing is adapted to be frictionally slidably disposed within the inlet end of the plug body and rests against an internal shoulder therein. A “probe tip” actuator is then slidably inserted through the inlet end of the plug and pushed into frictionally retained engagement with the thermal bushing, with the probe tip passing through the bushing and into the bore of the plug body. When the plug body assembly is then connected to the adjoining coupling part, the cylinder valve mechanism applies a spring force to the probe tip which holds the thermal bushing in shear between the probe tip and an internal shoulder of the plug body. As in the preceding embodiment, when the coupling is exposed to an elevated temperature within a predetermined range, the thermally responsive bushing will yield, allowing the spring force applied by the cylinder valve mechanism and the existing fluid pressure on the probe tip to axially move the probe tip downstream of the fluid flow, in a manner similar to that described above with respect to the first embodiment. Once the probe tip so moves, a gas-check poppet member in the cylinder valve mechanism moves to shut off the flow of gas. Also, similar to the previous embodiment, the bushing can be formed with recesses or holes that alter the thermal activation characteristics of the coupling.

These and other features, objects and advantages of the present invention will become apparent upon reading the following description thereof together with reference to the accompanying drawings.

### BRIEF DESCRIPTION OF DRAWINGS

FIG. 1 is a side elevational view illustrating one embodiment of a fluid-carrying member for use in the invention;

FIG. 2 is a partially sectioned side view illustrating the thermally responsive bushing;

FIG. 3 is a centrally sectioned side view illustrating the coupling nut;

FIG. 4 is a side elevational view of the nut of FIG. 3;

FIG. 5 is an end view of the nut of FIG. 3, further illustrating the bushing end of the nut;

FIG. 6 is an assembly view of the coupling illustrating the fluid-carrying member, bushing, and nut in assembled relationship, utilizing the sectional view of the nut shown in FIG. 3;

FIG. 7 is an assembly view showing the structure of FIG. 6 following thermal release;

FIG. 8 is an end view of the bushing of FIG. 2, illustrating an alternate embodiment of the flange of the bushing;

FIG. 9 is an end view of the bushing of FIG. 2, illustrating another alternate embodiment of the flange of the bushing; and

FIG. 10 is an assembly view illustrating an alternate embodiment of the heat-sensitive coupling for a Type II connection.

### DETAILED DESCRIPTION OF THE PREFERRED EMBODIMENT

The thermally responsive coupling of the present invention is intended for principal use in and with gas safety disconnect systems, particularly as shown and described in commonly-assigned U.S. Pat. No. 5,582,201.

Referring now to the drawings, and more particularly to FIG. 1, a fluid-carrying plug-like member, e.g., an L.P. gas POL fitting (which is normally made of brass and therefore heat-conductive), is generally shown at 10 to represent the part of the coupling through which fluid (e.g., gas) flows between two fluid-carrying conduits (not shown). Head 20 of fluid-carrying member 10 has a first inlet end 17 including a convexly divergent annular shoulder 19, which abuts against and actuates a first fluid- carrying apparatus, e.g., a valve member having an annular end extremity (not shown), when the assembly is fully engaged. In addition, fluid-carrying member 10 has a second end 12, which, in one embodiment, is threaded for connection to a fluid-carrying conduit or apparatus such as a pressure-regulator and an appliance such as a gas grill (also not shown). The fluid-carrying member 10 also has a central cylindrical outer surface 16, an annular abutment wall 18, and an annular groove 14, which are adapted to accommodate the thermally sensitive bushing described below. When fully engaged, the system allows fluid to flow into and through an axial passage extending through fluid-carrying member 10. In this fashion, fluid may flow through the fluid-carrying member 10 from head 20 and out, in one embodiment, the conically tapered and threaded second end 12, to the second fluid-carrying apparatus.

It should be noted that fluid-carrying plug member (e.g. POL) 10 may have a tubular cylindrical guide pin (not shown) extending outward from inlet end 17, as is known in the art, for sliding engagement with a cooperative passage in a complimentary coupling member of the first fluid-carrying apparatus (e.g., valve member) to which member 10 is to be coupled to assist in maintaining mutual alignment during coupling etc. Also, fluid-carrying member 10 may incorporate an internal or associated excess-flow shutoff valve, as for example is shown in the aforementioned U.S. Pat. No. 5,582,201 (or otherwise constructed). Since neither such feature is part of the thermally responsive structures or functions of the present invention, neither are shown or more particularly described herein.

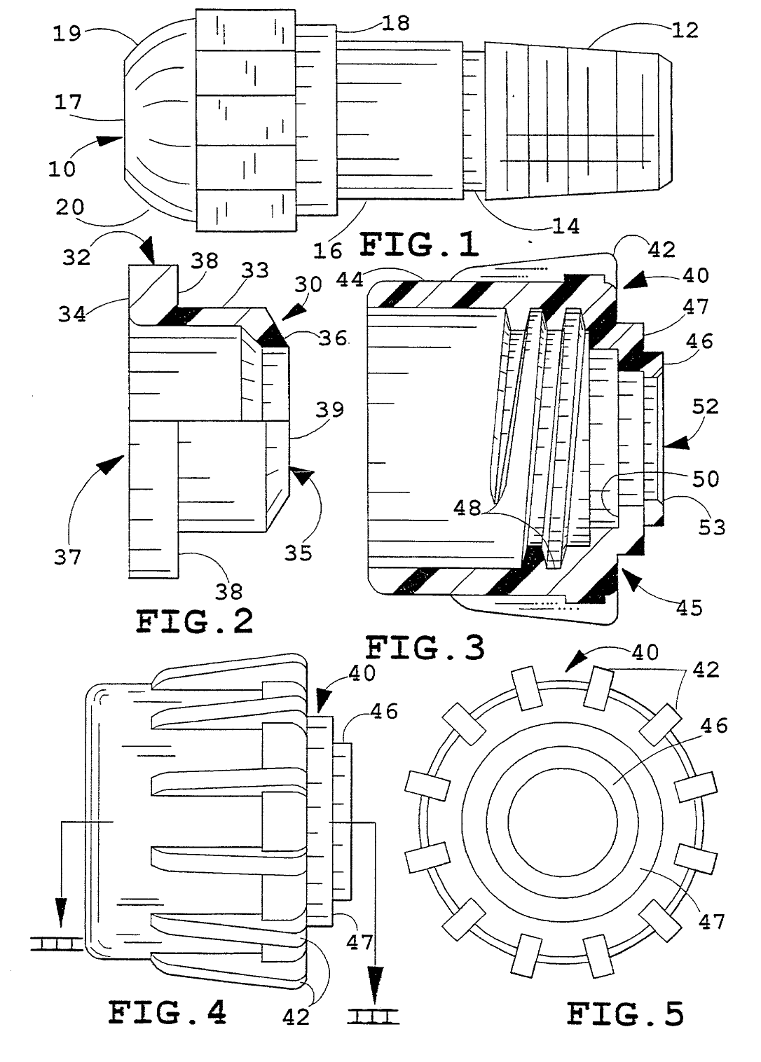

As best shown in FIG. 2, bushing 30 has a first end 37, a second end 35, and a thickened, radially projecting annular flange section 32 having a first side 34 and a second side 38. In addition, bushing 30 includes an annular wall 36 adjacent second end 35 which is angled convergently toward the central (longitudinal) axis of bushing 30 and adapted to engage annular groove 14 of fluid-carrying member 10. Between the flange section 32 and convergent wall section 36, bushing 30 includes a generally tubular middle section 33. As explained further hereinafter, tubular middle wall 33 and angularly convergent wall 36 desirably have particular predetermined relative wall thicknesses to provide optimum functional performance. Thickened flange section 32 extends annularly and coaxially around the longitudinal axis X of a central bushing bore 39, and its second side 38 circumferentially engages an inner annular wall 50 of a nut 40 (FIGS. 3 and 5). In the preferred embodiment, e.g., when used in L.P. gas barbecue grills, bushing 30 is made of a high-density polyethylene material which provides thermal activation (described below) between approximately 240° F. and 300° F. as well as resistance to chemical attack.

Next, as best illustrated in FIG. 3, nut 40 of the coupling includes a hollow cylindrical body 44 with a partially closed end 45 having a relatively uniform wall thickness, which tapers outwardly in a series of steps, including an annular shoulder 47 (FIGS. 3, 4, 5), extending convergently toward the longitudinal axis of the coupling. Partially closed end 45 of nut 40 terminates at a radially inwardly extending hooded end wall 46 that has a chamfered edge 53 which lies generally annular external end 36 of bushing 30 when the coupling is assembled, as shown in FIG. 6 (described below). Nut body 44 has a bore 52 and contains an internally threaded portion 48 which is adapted to engage the threaded end of an input apparatus such as a coupling or valve housing (as shown in the referenced U.S. Pat. No. 5,582,201) in order to connect the components of a fluid-carrying system. Nut body 44 also contains annular inner wall 50 near its partially closed end which abuts against second wall 38 of bushing 30 when the coupling is assembled. Finally, nut 40 preferably contains a series of fin-like grips 42 which are equally spaced around the entire outer surface of nut body 44 as best shown in FIGS. 4 and 5.

FIG. 6 shows a coupling 60, including its three major components (fluid-carrying member 10, bushing 30, and nut 40) after it has been assembled as follows. First, bushing 30 is inserted through the large open end of nut 40 until second annular wall 38 of bushing 30 abuts against inner annular wall 50 of nut body 44. In their original (as-manufactured) configuration, the assembled nut body 44 and bushing 30 define an annular void 62 between interior annular surface 43 of the nut body and middle section 33 of bushing 30. The purpose of void 62 will be readily apparent from the discussion below pertaining to the thermal activation feature of the coupling. Next, fluid-carrying member 10 is inserted into the nut body 44 through its larger open end, and into first end 37 of bushing 30, where it enters bushing bore 39 (the entrance to which is preferably radiussed as shown in FIG. 2). Although bushing bore 39 (FIG. 2) is more narrow at second end 35 of bushing 30 than at first end 37 thereof in the as-manufactured configuration, the angularly extending annular end wall 36 of bushing 30 is resiliently deformable and, therefore, fluid-carrying member 10 may be pushed directly through second end 35 of bushing 30 by forcing wall 36 to flare diametrically outward (see FIG. 6).

As fluid-carrying member 10 is progressively inserted through bushing bore 39, convergent annular wall 36 of bushing 30 (which is preferably made of a stiffly flexible high-density polyethylene material) is forced radially outwardly (i.e., flared) into the slightly angular but generally cylindrically tubular shape illustrated in FIG. 6. This creates a spring force (directed radially inwardly) around the circumference of end 35 of annular external end wall 36. When fluid-carrying member 10 has been fully inserted into bore 39 of bushing 30, the resiliently flared annular external end 35 of wall section 36 engages annular groove 14 in fluid-carrying member 10 and, due to said spring force, grips fluid-carrying member 10 around the circumference of groove 14 to retain this relative positioning of the two such parts. In addition, because it has been expanded radially outwardly, annular angled portion 36 of bushing 30 is forced into a position closely adjacent to, but slightly beyond, the end wall 46 of nut body 44. As a result, both fluid-carrying member 10 and bushing 30 are locked into nut 40 since the angular junction of bushing walls 33 and 36 forms an annular ridge 41 which interlocks with the inner diametrical edge of nut body end wall 46, at the base of chamfer 53, to resist axial displacement of bushing 30 from right-to-left as seen in FIG. 6.

The interlock effect just noted is augmented by relief chamfer 53 (FIG. 3), which preferably extends around the exit edge of hooded outer wall 46 at an angle of about 23°. When the components 10, 30, and 40 have been assembled as described above, relief chamfer 53 is disposed generally parallel to resiliently flared ridge portion 41 of external end 36 of bushing 30, with angled portion 41 slightly overlapping the primary inside diametrical surface 51 of hooded wall 46 (FIG. 6). It is to be noted that the shape and thicknesses of sections 32, 33, and 36 of bushing 30 are preferably optimized so that the pronounced outward resilient flaring of angled wall 36 during insertion of the fluid-carrying component 10 is localized at, and forms, an annular ridge portion 41 located at the juncture of cylindrical wall 33 and angular wall 36. In this regard, wall 36 is preferably tapered somewhat, as shown in FIG. 2, being wider at its junction with wall 33. The structures and stresses just described, increase the retentive effect of bushing 30 on fluid-carrying member 10 while allowing nut 40 to rotate relative to bushing 30 even though these two components are interlocked together, so that nut 40 may be readily threaded manually onto a cooperative coupling part having complementary threading, e.g., a valve housing. A specific example of a preferred embodiment of bushing 30 has the following dimensional relationship: flange section 32, 0.212″ thick; wall section 33, 0.044″ thick; tapered wall section 36, 0.068″ (nominal) thick; and bushing bore 39 0.446″ I.D. Since angled wall section 36 is thicker than wall section 33 in this optimized configuration, resilient flexure occurs primarily in wall section 33, i.e., at ridge portion 41.

The operation of coupling 60 is as follows. With fluid-carrying member 10, bushing 30, and nut 40 assembled and interlocked, a first fluid-carrying apparatus, such as a valve housing (not shown), is threadably connected to freely rotatable nut 40 by the internal threads 48 of the latter. As this interconnection is tightened, a spring-loaded valve member inside the valve housing (also not shown) abuts inlet end 17 of fluid-carrying member 10 and is gradually moved to an open position thereby, against the force of a spring which normally holds the valve closed. This subjects inlet end 17 of fluid-carrying member 10 to a force (designated “F” in FIG. 6) but, because interior shoulder wall 18 of fluid-carrying member 10 directly abuts bushing 30 at its first wall 34, this force is transferred to flange 32 of bushing 30, and through it to adjacent inner wall 50 of nut body 44.

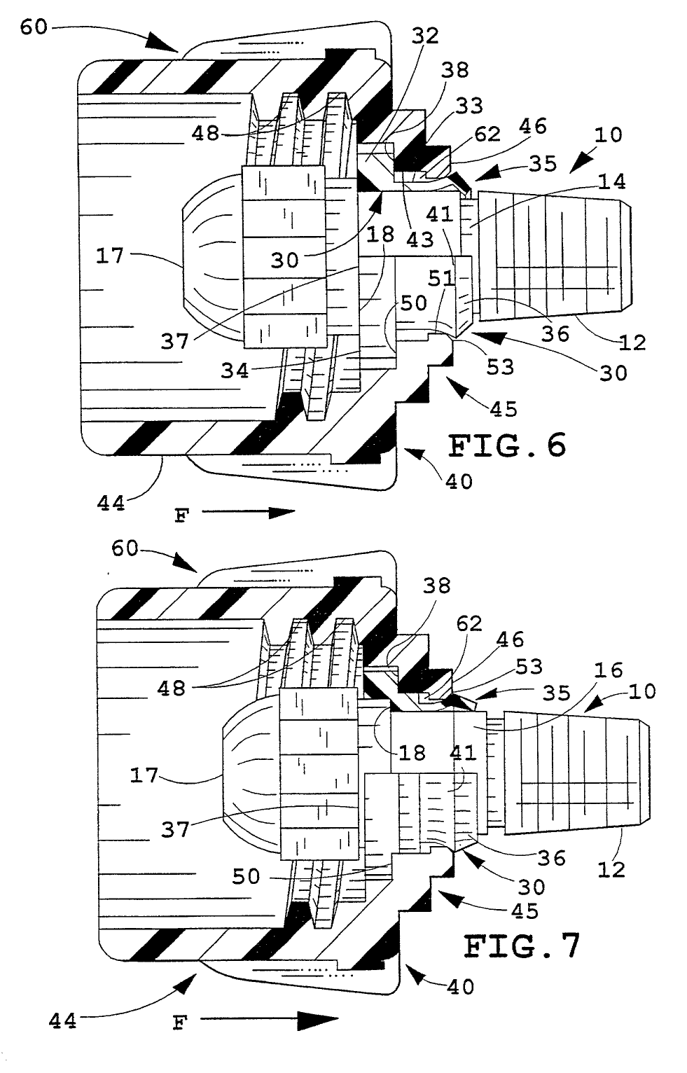

Under normal ambient temperature conditions, and typical force loads, flange 32 resists axial displacement (from left-to-right in FIG. 6) of fluid-carrying member 10. If the temperature surrounding the coupling 60 increases, as in the case of a fire, nut 40 and the components within it become heated. As this occurs, thickened annular flange 32 of bushing 30 softens and, because first wall 34 of flange 32 is in shear between abutting wall 18 of fluid-carrying member 10 and annular inner wall 50 of nut 40, when a predetermined ambient temperature is reached and bushing 30 has softened a predetermined amount in response, the force F will cause wall 18 to displace a portion of softened polyethylene flange 32 into adjacent void 62. This displacement of a portion of flange 32 of bushing 30 allows corresponding axial movement of fluid-carrying member 10, as illustrated in FIG. 7, and of the aforementioned spring-loaded valve member in contact with it, to trigger a “gas-check” (not shown) in the valve which stops the flow of fluid through coupling 60. According to another feature of the invention, even though fluid-carrying member 10 moves from left-to-right (as seen in FIGS. 6 and 7) to disengage the fluid connection, nut 40 remains connected to the valve housing and does not undergo axial movement. Also, despite the softening and subsequent change in shape of flange 32, bushing 30 experiences little overall axial movement. As best shown in FIG. 7, upon thermal activation, annular end portion 36 remains in essentially the same position, with its inside diameter gripping cylindrical outer surface 16 of fluid-carrying member 10 and its outer ridge 41 disposed closely adjacent nut body end wall 46 and its relief chamfer 53. In the preferred embodiment, e.g., when used in a L.P. gas barbecue grill system, this thermal activation of bushing flange 32 desirably occurs within a temperature range of about 240°-300° F.

Note that the design of this invention minimizes the undesirable effects associated with axial displacement, i.e., creep, of the thermally activated element below the desired range of thermal activation and that when activated, the softened material of bushing flange 32 does not necessarily shear completely through because the thickness of the flange is at least slightly more than the desired distance of axial motion for gas-check valve actuation.

It is to be further noted that various alternate embodiments of fluid-carrying member 10 may be used in carrying out the invention, particularly with respect to the configuration and general nature of the outlet end portion 12. For example, the threaded extremity described above may have either tapered or straight threading, or also may instead have an unthreaded press-in configuration. Depending on the application, various other types of termination connection ends can be used, such as barbed, swaged, etc. This merely suggests other particular forms and applications of the apparatus, however, and should be understood as being representative of known coupling configurations generally, apart from the internal thermal-relief elements as described above.

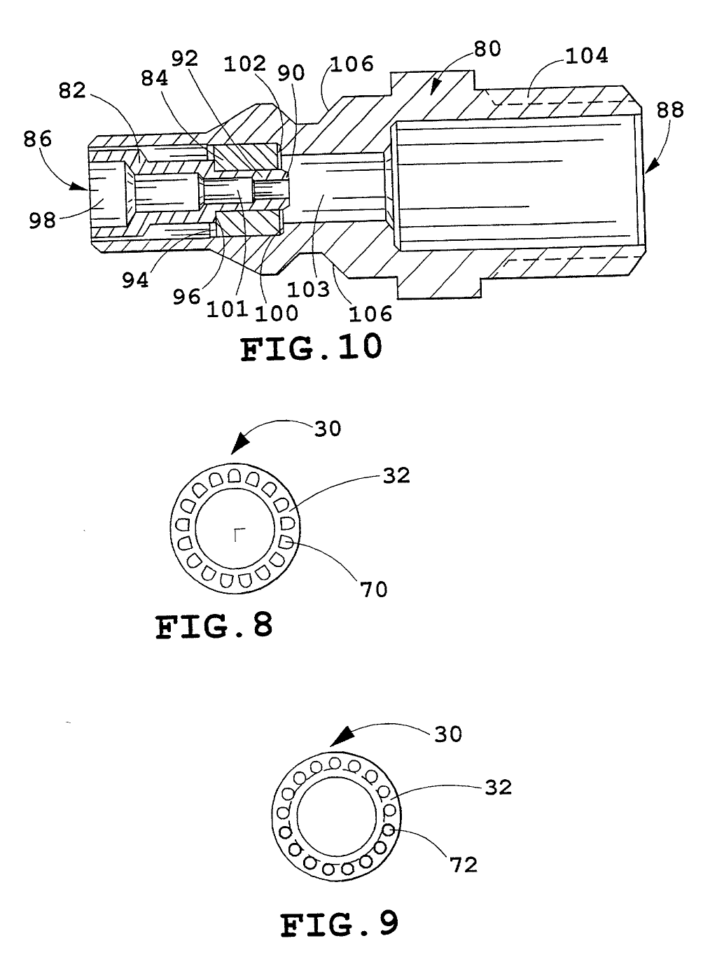

Turning to FIGS. 8 and 9, according to another feature of the present invention, holes or recesses 70, 72 may be added to flange 32 of bushing 30 to reduce the effective shear section and therefore modify the thermal activation characteristics of coupling 60; e.g., the axial displacement of fluid-carrying member 10 per unit of time as a function of temperature. As shown in FIGS. 8 and 9, apertures 70, 72 of selected size and shape may be spaced around flange 32 of bushing 30, with the axis of each such aperture parallel to the axis of coupling 60. In this embodiment of bushing 30, the amount of material that must soften in order to release fluid-carrying member 10 is reduced, thus varying the activation characteristics of the automatic disconnect feature. Typically, with less material, thermal activation will occur at a temperature at the lower end of the thermal activation range (for example 240°-300° F. for L.P. gas barbecue grills). Alternatively, with apertures 70, 72 formed in bushing 30, other specific materials may be used while maintaining similar thermal activation characteristics.

A further embodiment of the thermally responsive fluid coupling that has similar structure and includes the same basic thermal release feature as the previous embodiment is shown in FIG. 10. This embodiment of the invention is particularly (although not exclusively) useful in quick-disconnect or “Type II” gas connections such as are commonly used in the gas grill industry. The type of connection is shown in FIG. 10, and includes a plug body 80 for transporting fluid from a fluid source (not shown) to an appliance (also not shown), that has a plug-in type inlet end 86, an axial bore 98, and an outlet end 88. As stated above, plug body 80 may be the first part of a standard Type II connection that is adapted to be releasably connected to a second part of the Type II connection, e.g., a cylinder valve which, (as is well known), includes a spade member and a gas-check poppet member (not shown) for controlling the flow of fluid. As will be understood, the socket which receives inlet end 86 (which may comprise the housing of the cylinder valve) has spring-loaded ball elements (not shown) that are adapted to engage an annular notch 106 around the outer perimeter surface of plug body 80 to hold the socket/cylinder valve and the plug body together, even upon thermal activation. Outlet end 88 of plug body 80, in the preferred embodiment, has threads 104 for connection to an appliance or another fluid-carrying conduit.

Similar to the previous embodiment, the fluid-carrying member (e.g., plug body) includes an independent thermal release member 84 that, when subject to temperatures within a predetermined range, softens to release the components of the system and disconnect the fluid connection. As best shown in FIG. 10, the thermal member 84 preferably comprises a generally tubular bushing that is sized to be press-fit into plug body 80 through its inlet end 86, and has a central bore or passage for permitting fluid to pass through plug body 80 received via an actuator or probe tip, 82. It should be noted that the cylindrical outer periphery of the thermally responsive member 84 and/or of the corresponding inside surface of the plug body 80 into which it frictionally fits may be splined or otherwise ridged to vary the thermal conductivity characteristics therebetween, thus varying the thermal responsive time of the coupling. A similar effect may be obtained by varying the amount of interference in the press-fit relation between the plug body and thermally responsive member, and/or by varying the length and diameter of these surface. It should also be noted that the outer periphery of probe tip 82 is sized to be press-fit within the thermal member 84, but slidably disposed with the inlet end 86 of plug body 80, and analogous measures may also be used to vary the thermal conductivity of this press-fit engagement.

To assemble the thermally activated plug assembly, thermal bushing 84 is inserted into inlet end 86 of plug body 80 and pressed into place with outwardly facing flat surface 102 of bushing 84 abutting against an internal shoulder 100 of the plug body, which prevents further inward movement of thermal member 84. Next, probe tip 82 is slidably inserted into inlet end 86 of plug body 80, with a reduced-diameter portion 92 of the probe tip entering and extending through an axial passage 101 in thermal member 84, between which a frictional (interference) fit exists. The interference fit between these components maintains their relative positions during shipment and handling, etc. As illustrated, portion 92 of probe tip 82 extends entirely through the central bore of thermal member 84, with an extended end 90 protruding into an interior bore 103 of plug body 80. When plug body 80 is inserted into the cylinder valve and a spring force is thus applied to probe tip 82, further axial movement of probe tip 82 in the direction of fluid flow is prevented because annular shoulder 96 of probe tip 82 abuts the outwardly facing flat surface 94 of thermal member 84. Thermal member 84 is therefore held in shear between interior shoulder 100 of plug body 80 and annular exterior shoulder 96 of probe tip 82. When the two components of the connection are secured, the gas-check poppet of the socket or valve body is moved to an open position against a spring force created in the cylinder valve, which normally holds the valve closed. This spring force acts on probe tip 82 and, hence, is transferred to thermal member 84 and interior shoulder 100 of plug body 80.

Under normal ambient temperature conditions, thermal member 84 resists axial compression in response to the spring force on probe tip 82 acting in the direction of fluid flow (left-to-right in FIG. 10). However, when a fault condition occurs, e.g., the coupling is exposed to an elevated temperature within a predetermined range, thermal member 84 will soften and, as a result, probe tip 82 will be moved by the cylinder valve spring force. Therefore, probe tip 82 will shear the softened material of thermal member 84 and move axially in bore 98 of plug body 80. This movement of probe tip 82 will allow corresponding movement and, thus, closure of the cylinder valve gas-check poppet member to shut off the flow of gas. Once again, the shearing effect exerted on thermal member 84 does not necessarily shear this member completely through because when it softens and yields at elevated temperatures the thickness of this member is at least slightly greater than the desired resistance of axial motion for gas-check valve actuation.

Similar to the previous embodiment, this second embodiment minimizes “creep” because it is formed of a relatively strong material (e.g., polyethylene) and a substantial portion of the shear surfaces, including shoulder 100, flat surfaces 102, 94, and shoulder 96 abut flat against one another, thus providing a highly secure coupling. Also, by utilizing an independent thermal member 84, the coupling can be readily modified to achieve particular desired thermal activation characteristics for a wide variety of applications with minimal difficulty and expense. For instance, similar to the previous embodiment, thermal member 84 may be formed with ribs or apertures parallel to the axis of fluid flow (like apertures 70, 72 of FIGS. 8 and 9) to reduce the effective shear area and, thus, vary the temperature range at which thermal activation occurs. Further, the use of selected alternate materials in the manufacture of the thermal member may provide desired changes in specific thermal response while maintaining the desired basic thermal activation characteristics. Overall, this embodiment of the invention allows straightforward physical assembly of the components and minimizes manufacturing expense while maintaining the integrity and variability of the thermal release feature.

The above description is considered that of preferred embodiments only. Modifications of these embodiments will occur to those skilled in the art and to those who make or use the invention. Therefore, it is to be understood that the embodiments shown in the drawings and described above are merely for illustrative purposes and should not serve to limit the scope of the invention, which is defined by the following claims as interpreted according to the principles of patent law, including the doctrine of equivalents.

The claimed invention is:

1. A fluid coupling for connecting first and second fluid conduits comprising:
a fluid-carrying member having an inlet end for receiving fluid from the first fluid conduit and an outlet end for dispensing fluid to a second fluid conduit coupled thereto;
a collar disposed about said fluid-carrying member, said collar having a first end adapted to be releasably connected to a cooperative coupling member connected to the first fluid conduit, and having a second end through which at least one of said outlet end of said fluid-carrying member or said second fluid conduit extends;
a bushing having a central bore for receiving said fluid-carrying member, having an integral thermally responsive portion, and having a deflectable portion engaging said fluid-carrying member and retaining said bushing in place with respect thereto; and
said fluid-carrying member, said collar and said bushing being serially connected together and having interengaging structures including said thermally responsive portion and said deflectable portion of said bushing to preclude relative axial movement therebetween in at least one direction, and said thermally responsive portion being yieldable in response to predetermined elevated temperatures to permit at least limited relative axial movement between said fluid-carrying member and said collar in said at least one direction.

2. A fluid coupling according to claim 1, wherein said bushing is sized and shaped to be receivable through said first end of said collar and said fluid-carrying member is receivable through said central bore of said bushing, said bushing having a resiliently biased portion engaging said second end of said collar to preclude relative axial movement between said collar, said bushing and said fluid-carrying member in at least one direction.

3. A fluid coupling according to claim 2, wherein said bushing includes resiliently deformable portions and at least one such portion comprises said resiliently biased portion.

4. A fluid coupling according to claim 2, wherein said thermally responsive portion of said bushing is disposed generally between said collar and said fluid-carrying member when serially connected together.

5. A fluid coupling according to claim 2, wherein said thermally responsive portion is structured to yield in response to an axial force applied to said fluid-carrying member when the fluid coupling is exposed to said predetermined elevated temperatures, thus permitting said relative axial movement of said fluid- carrying member and collar.

6. A fluid coupling according to claim 1, wherein said second end of said collar has a series of integral concentric annular sections to enhance transmittal of external heat into said collar.

7. A fluid coupling according to claim 6, wherein said series of concentric annular sections has at least one such section that is positioned to abut at least a portion of said bushing when said bushing and said collar are assembled together.

8. A fluid coupling according to claim 7, wherein at least a portion of said at least one section of said collar includes a chamfered annular surface to facilitate relative rotational movement between said collar and said bushing when the two are assembled.

9. A fluid coupling according to claim 4, wherein said predetermined elevated temperatures are within the range between 240° and 300° F.

10. A fluid coupling comprising:
an inner member for carrying fluid;
an outer member generally telescoped over said inner member and having a first end adapted to be releasably connected to a cooperative coupling portion; and
a bushing slidably positionable along said inner member and disposed between said inner member and said outer member, said bushing having a portion that is deformable in a direction at least partially generally axially thereof to normally retain said members together in interlocking engagement against relative axial movement while permitting rotational movement of said outer member relative to both said bushing and said inner member and thereby connect said outer member to said cooperative coupling portion, deformation of said deformable portion releasing said interlocking engagement sufficiently to permit at least some axial movement of said inner and outer members.

11. A fluid coupling according to claim 10, wherein said bushing, said inner member and said outer member comprise the principal elements of the coupling and such elements are relatively sized and configured to be slidably interengaged for rapid assembly.

12. Cancelled.

13. A fluid coupling according to claim 10, wherein said bushing comprises a thermally responsive member operative to undergo said deformation and provide at least limited axial release of said inner member at an elevated temperature range.

14. A fluid coupling according to claim 11, wherein said principal elements have mutually abutting surfaces that normally preclude relative axial movement of the elements in at least one direction.

15. A fluid coupling according to claim 14, wherein at least one of said mutually abutting surfaces comprises a thermally yieldable structure that has predetermined thermal release characteristics and which upon yielding permits at least a certain amount of said relative axial movement.

16. A fluid coupling according to claim 15, wherein said thermally yieldable structure has openings formed therein for altering the thermal release characteristics of said structure.

17. A fluid coupling according to claim 10, wherein said inner member and said bushing provide an interengageable detent structure for releasably securing them together.

18. A thermally responsive coupling for releasably connecting a fluid source to an appliance through a fluid-carrying member, wherein the fluid-carrying member is subject to a force tending to urge the fluid-carrying member downstream of the fluid flow, comprising:
a principal structural coupling portion; and
a thermally responsive member for resisting the force tending to urge the fluid-carrying member downstream, said thermally responsive member having integral thermally responsive portions which yield in response to elevated temperatures;
said thermally responsive member interfitting conjointly with said principal structural coupling portion such that at least a portion of said thermally responsive member is positioned to be under shear stress between the fluid-carrying member and said principal structural coupling portion, whereby said at least a portion of said thermally responsive member under shear stress softens and ceases to resist the force tending to axially displace the fluid-carrying member when the ambient temperature increases to within a predetermined range, thereby shearing and allowing the fluid-carrying member to move downstream of the fluid flow to shut off the fluid connection.

19. In a fluid coupling for connecting first and second fluid conduits, of the type having mutually cooperative and interconnectable first and second coupling members respectively connectable to said first and second fluid conduits, the improvement comprising:
a fluid-carrying member having a first end for receiving fluid from the first fluid conduit, and a second end for dispensing fluid to the second fluid conduit;
a bushing having a first end and a central bore for receiving at least a portion of said fluid-carrying member, having an integral thermally responsive portion, and having a second end for engaging said second coupling; and
a collar comprising said second coupling member and having a first portion adapted to be releasably connected to said first cooperative coupling member, said collar having a second portion through which at least one of said second end of said fluid-carrying member or said second fluid conduit extends;
said fluid-carrying member, said collar and said bushing being serially assembled to preclude relative movement in at least one axial direction, and said first end of said fluid-carrying member being adapted to communicate with at least a portion of said first cooperative coupling member and to receive an axial force therefrom directed toward said second end of said fluid-carrying member.

20. The improvement for a fluid coupling according to claim 19, wherein said integral thermally responsive portion of said bushing is disposed between said fluid-carrying member and said collar and subjected to shear forces therebetween so that when the coupling is exposed to a temperature within a predetermined range said thermally responsive portion softens and yields to said shear forces, thereby ceasing to resist said axial force and permitting movement of said fluid-carrying member.

21. In a fluid coupling for connecting first and second fluid conduits, of the type having mutually cooperative and interconnectable first and second coupling members respectively connectable to said first and second fluid conduits, the improvement comprising:
a first cooperative coupling member having an end opening and an internal shoulder, and a fluid-conveying member disposed at least partially inside said first cooperative coupling member, said fluid-conveying member having a first end portion adapted to be releasably engaged by said second cooperative coupling member, having an axial bore, and having a shoulder, said first cooperative coupling member shoulder being spaced from said fluid-conveying member shoulder; a thermally releasable member sized to be inserted into said end opening of said first cooperative coupling member and configured to abut said shoulder of said first coupling member when so inserted, said thermally releasable member sized and shaped to receive said shoulder of said fluid-conveying member and being disposed in shear between said two shoulders when so assembled; and
whereby, when so assembled, a force exerted on said thermally releasable member by said fluid-conveying member tending to axially urge said thermally releasable member toward said shoulder of said first cooperative coupling member will be resisted at ambient temperature conditions less than those at which said thermally releasable member yields, to prevent such axial movement of said fluid-conveying member, but upon thermal yielding of said releasable member at higher ambient temperatures said force acting to move said fluid-carrying member downstream of said fluid flow.

22. The improvement in a fluid coupling according to claim 21, wherein said higher ambient temperatures include the range of between 240° F. and 300° F.

23. A thermally responsive coupling member for connection to a cooperative coupling member having a valve member therein that allows fluid to flow into said thermally responsive coupling member when releasably connected thereto, comprising;
a coupling member body connectable to said cooperative coupling member;
a fluid-carrying member slidably insertable into said coupling member body;
a thermally responsive member disposed at least partially within said coupling member body and having a central bore receiving at least a portion of said fluid-carrying member;
said thermally responsive member and said fluid-carrying member having interengaging force-fitted resiliently deflected portions which retain said members in mutually connected relation; and
said thermally responsive member having portions disposed in shear between at least an internal portion of said coupling member body and said fluid-carrying member, said shear-disposed portions normally resisting a force exerted by said cooperative coupling member tending to displace said thermally responsive member relative to said coupling member body at ambient temperature conditions but yielding to said forces at elevated temperatures to thereby permit said movement and thereby release the valve member of said cooperative coupling member to shut off the flow of fluid through the coupling.

24. A thermally responsive coupling member according to claim 23, wherein said thermally responsive member has portions which extend outwardly beyond said coupling member body, said fluid-carrying member, has portions which extend outwardly beyond said thermally responsive member and said outwardly extending portions of said thermally responsive member are disposed in mutually interlocking relation with portions of both said fluid carrying member and said coupling member body to maintain an assembled status therebetween.

25. A thermally responsive coupling member according to claim 24, wherein at least a part of said outwardly extending portions of said thermally responsive member are resiliently flexibly deformed in said interlocking relationship.

26. A thermally responsive coupling member according to claim 25, wherein said outwardly extending portions of said thermally responsive member include a wall section which projects toward and engages said fluid-carrying member in detenting relation.

27. A thermally responsive coupling member according to claim 26, wherein said thermally responsive member comprises a generally tubular body having a heat-responsive flange disposed between adjacent portions of said fluid-carrying member and of said coupling member body.

28. A thermally responsive coupling member according to claim 27, wherein said heat-responsive flange and said adjacent portions of said fluid-carrying member and said coupling member body are sized and shaped relative one another so as to subject said flange to shear stress when in said assembled status.
